(19) United States
(12) Patent Application Publication
(10) Pub. No.: US 2017/0092145 A1
(43) Pub. Date: Mar. 30, 2017

(54) SYSTEM, METHOD AND NON-TRANSITORY COMPUTER READABLE STORAGE MEDIUM FOR TRULY REFLECTING ABILITY OF TESTEE THROUGH ONLINE TEST

(71) Applicant: INSTITUTE FOR INFORMATION INDUSTRY, TAIPEI (TW)

(72) Inventor: Chan-Hsien LIN, New Taipei City (TW)

(21) Appl. No.: 14/924,735

(22) Filed: Oct. 28, 2015

(30) Foreign Application Priority Data
Sep. 24, 2015 (TW) 104131618

(51) Int. Cl. G09B 7/02

(52) U.S. Cl. CPC G09B 7/02

(57) ABSTRACT

A system, method and non-transitory computer readable storage medium for truly reflecting the ability of the testee through an online test are provided. The method includes: providing an online test to be participated by a testee, wherein the online test comprises at least one examination question, recording an answer of the examination question given from the testee and answering time spent by the testee, determining whether the answer is correct; and when the answer is determined to be correct, providing a latest academic ability of the testee according to a determination result whether the answering time of the testee is within a predetermined range.

### This application claims priority to Taiwan Application Serial Number 104131618, filed Sep. 24, 2015, which is herein incorporated by reference.

### BACKGROUND

Field

The present disclosure relates to a system, method and non-transitory computer readable storage medium for reflecting ability of a testee, and more particularly, for truly reflecting the ability of the testee through an online test.

Description of Related Art

With the improvement of network stability and development of website design, online learning becomes a trend. A user can learn online via a remote device without any time limit, and an outcome of this learning is evaluated through a subsequent online test; or it is not necessary for the user to learn online, but the ability degree of the user in a certain tested field is obtained from an independent online test.

However, most of conventional test assessing approaches depend only on the number of correct answers given from the user in the test, wherein the number is used as an indicator for evaluating the ability degree of the user, but it cannot be determined whether the user really understands or just speculates the answer when the user gives a right answer of the examination question, resulting in inaccurate determination of true ability degree of the user. Furthermore, since the conventional test assessing approaches cannot precisely determine the true ability degree of the user, of course no appropriate learning plan can be proposed subsequently.

It can be seen that the aforesaid technology obviously still has inconvenience and disadvantages, which needs to be further improved. Thus, many in the industry are endeavoring to find ways in which to effectively solve the aforementioned inconvenience and disadvantages.

### SUMMARY

An aspect of the present disclosure is to provide a system and a method for truly reflecting ability of a testee through an online test, and he method for truly reflecting ability of the testee through the online test may be implemented by a program and stored in a non-transitory computer readable storage medium. The system and the method can solve the aforementioned problems of the prior art, i.e., truly reflecting the academic subject ability value of the testee.

According to an embodiment of the present disclosure, the method for truly reflecting the ability of the testee through an online test includes steps as follows. An online test is provided to be participated by a testee in which the online test includes an examination question. Answer of the examination question given from the testee and answering time for giving the answer by the testee are recorded. A determination whether the answer is correct is made. If the answer is correct, the latest academic ability of the testee is provided based on the determination result whether the answering time is within a predetermined range.

Therefore, based on the reliability of the correct answer given by the testee for a specific examination question, i.e., deducing whether the testee really understands or just speculates the answer when the testee gives the right answer, the aforementioned method can precisely determine the real ability degree of the user, so as to suggest an appropriate learning plan subsequently.

According to one or more embodiments of the present disclosure, the step of providing the latest academic ability of the testee based on the determination result whether the answering time is within a predetermined range further includes steps as follows. It is determined whether the answering time is within a predetermined range. If it is determined that the answering time is within the predetermined range, based on this determination result a first weight of the previous academic ability of the testee is provided, and a latest academic ability is provided based on the calculation of the first weight and the preset difficulty degree of the examination question.

According to one or more embodiments of the present disclosure, when it is determined that the answering time is not within the predetermined range, it is determined whether the previous academic ability of the testee matches the preset difficulty degree of the examination question. When it is determined that the previous academic ability matches the difficulty degree, based on the determination result whether the previous academic ability matches the difficulty degree a second weight of the previous academic ability of the testee is provided, and a latest academic ability is provided based on the calculation of the second weight and the difficulty degree.

According to one or more embodiments of the present disclosure, when it is determined that the previous academic ability doesn't match the difficulty degree, based on the determination result whether the previous academic ability matches the difficulty degree a third weight of the previous academic ability of the testee is provided, and a latest academic ability of the testee is provided based on the calculation of the third weight and the difficulty degree, wherein the third weight is less than the second weight.

According to one or more embodiments of the present disclosure, if the answer is not correct, based on a determination result whether the answer is correct, a fourth weight of the previous academic ability of the testee is provided, and a latest academic ability of the testee is provided based on the calculation of the fourth weight and the preset difficulty degree of the examination question, wherein the third weight is between the second weight and the fourth weight.

According to one or more embodiments of the present disclosure, when the online test includes multiple examination questions, the number of these examination questions is n, the difficulty degree of each examination question is dᵢ, one of the aforementioned first to fourth weights is aᵢ, and the latest academic ability is p, the test satisfies the following relational expression:

$$p = \frac{{\sum }_{i = 1}^{n} ( 1 - {d}_{i} ) \times {a}_{i}}{n} ,$$

wherein 1≧dᵢ≧0, 1≧aᵢ≧0.

According to one or more embodiments of the present disclosure, the step of determining whether the answering time is within the predetermined range further includes the following step. The answer reliability of the examination question is calculated according to the answering time, the mean answering time of the examination questions, and the mean standard deviation of the examination questions. It is determined whether the answer reliability is not more than the preset standard deviation multiple. If the answer reliability is not more than the preset standard deviation multiple, it is determined that the answering time is within the predetermined range.

According to one or more embodiments of the present disclosure, when the answering time is tᵢ, the mean answering time is t̅ᵢ, the mean standard deviation of the examination questions is σᵢ, and the answer reliability is zᵢ, these parameters satisfy the following relational expression:

$${z}_{i} = \vert \frac{{t}_{i} - {\overline{t}}_{i}}{{σ}_{i}} \vert$$

According to one or more embodiments of the present disclosure, the step of determining whether the previous academic ability matches the difficulty degree further includes steps as follows. It is determined whether the sum of the previous academic ability and the difficulty degree is not less than 1, wherein both the difficulty degree and the previous academic ability are within a range formed by 0-1, the difficulty degree from 0 to 1 represents the difficulty degree from difficult to easy, and the previous academic ability from 0 to 1 represents the previous academic ability from bad to good. If the sum of the previous academic ability and the difficulty degree is not less than 1, it is determined that the previous academic ability matches the difficulty degree.

According to one or more embodiments of the present disclosure, the method further includes steps as follows. The previous academic ability of the testee is replaced by the latest academic ability. The latest academic ability is reported to the testee.

According to one or more embodiments of the present disclosure, the method further includes steps as follows. The mean answering time of the examination questions and the mean standard deviation of the examination questions are corrected based on the answering time spent by the testee for answering the examination question.

According to one or more embodiments of the present disclosure, the method further includes steps as follows. The preset difficulty degree of the examination question is corrected according to the answering time spent by the testee for answering the examination question.

According to one or more embodiments of the present disclosure, the method further includes steps as follows. Before it is determined whether the answer is correct, all of the action history of the testee participating in the online test is recorded.

According to an embodiment of the present disclosure, a system which truly reflects the ability of the testee through an online test includes a storing module, a network connection unit and a processing unit. The storing module is used for storing at least one online test which includes at least one examination question. The network connection unit is provided for a testee to participate in this online test on the network through at least one remote device. The processing unit is electrically connected to the storing module and the network connection unit, so as to record the answer of the examination question given from the testee through the remote device and the answering time spent by the testee, and if the answer is correct, a latest academic ability of the testee is provided based on a determination result whether the answering time is within a predetermined range.

As such, since the system entirely records the action history of the testee participating in the online test, such as the answer of the examination question, the answering time and the like, no time recording element or similar element is needed to be additionally developed, and then the latest academic ability of the testee is calculated accordingly through the action history.

According to one or more embodiments of the present disclosure, the system further includes a recording module of action history. The recording module of action history is used for recording all of the action history of the testee participating in the online test through the remote device into the storing module.

According to one or more embodiments of the present disclosure, the system further includes an answering-time calculation module. The answering-time calculation module is used for calculating the answering time spent by the testee for answering the examination question through the remote device based on all of the action history, and for accumulating and updating a mean answering time of previous examination questions and the mean standard deviation of the examination questions.

According to one or more embodiments of the present disclosure, the system further includes an ability diagnostic module and a determining module. The ability diagnostic module is used for calculating an answer reliability of the examination question, and the sum of the previous academic ability of the testee and the preset difficulty degree of the examination question according to the answering time, the mean answering time of the examination questions and the mean standard deviation. The determining module is used for determining whether the answer is correct, whether the answer reliability is not more than the preset standard deviation multiple, and whether the sum of the previous academic ability of the testee and the difficulty degree of the examination question is not less than 1. The ability diagnostic module further performs a calculation of the difficulty degree of the examination question and the weight provided by a corresponding determination result based on different determination results from the determining module, so as to provide a latest academic ability for updating the previous academic ability.

According to one or more embodiments of the present disclosure, the system further includes a parameter feedback module. The parameter feedback module is used for correcting the difficulty degree of the examination question according to the answering time of the examination question.

According to one or more embodiments of the present disclosure, the network connection unit is further used for transmitting the latest academic ability into the remote device.

The description above only illustrates the problem to be solved by the present disclosure, the technical means for solving the problem and the functions thereof. Detailed description of the present disclosure will be illustrated in the embodiments below with reference to relevant drawings.

### BRIEF DESCRIPTION OF THE DRAWINGS

In order to make the foregoing as well as other purposes, features, advantages, and embodiments of the present disclosure more apparent, the accompanying drawings are described as follows:

FIG. 1 illustrates a schematic view of a system for truly reflecting the ability of the testee through an online test according to an embodiment of the present disclosure;

FIG. 2 illustrates a block diagram of the server according to FIG. 1.

FIG. 3 illustrates a flow chart of a method for truly reflecting the ability of the testee through an online test according to another embodiment of the present disclosure;

FIG. 4A illustrates a flow chart of substeps of the step 304 of FIG. 3;

FIG. 4B illustrates a normal distribution diagram of all the previous answering times of a single examination question;

FIG. 5 illustrates a flow chart of substeps of the step 306 of FIG. 3;

FIG. 6 illustrates an examination-question data table used by the method of FIG. 3; and

FIG. 7 illustrates a block diagram of the server according to another embodiment of the present disclosure.

### DETAILED DESCRIPTION

A plurality of embodiments of the present disclosure are disclosed below with reference to the drawings. For purpose of clear illustration, various details in practice will also be illustrated in the description below. However, it should be understood that the present disclosure is not limited to these practical details. In other words, in some embodiments of the present disclosure these details in practice are unnecessary. Furthermore, for purpose of simplifying the drawings, some conventional common structures and elements are illustrated in the drawings in a simply schematic manner.

Since the conventional test assessing approaches provided in the prior art cannot precisely determine the real ability degree of the testee, in the present disclosure after it is determined that the testee gives the correct answer of a specific examination question, through the comparison between the answering time spent by the testee and the statistical data of previous answering times of the same examination question, the reliability of the correct answer given by the testee for a specific examination question is obtained, i.e., deducing whether the testee really understands or just speculates the answer when the testee gives the right answer, rather than determining that the testee truly understands the correct answer as long as the correct answer of the examination question is given by the testee, and thus the true ability degree of the testee can be precisely determined.

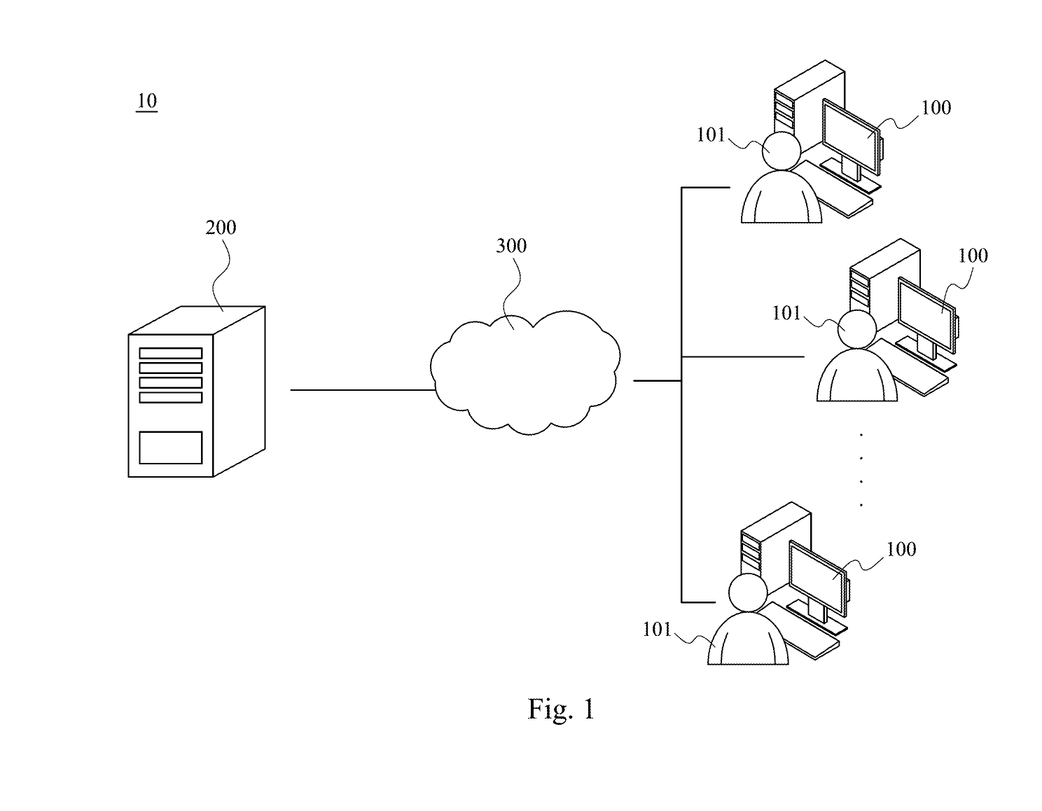

FIG. 1 illustrates a schematic view of a system for truly reflecting the ability of the testee through an online test according to an embodiment of the present disclosure. As shown in FIG. 1, in this embodiment, the system 10 includes one or more remote devices 100 and at least one server 200. The remote device 100 is connected to the server 200 through a network 300. As long as the remote device 100 is an Internet-connected device, the remote device 100 is not limited to a mobile phone, a notebook computer, a tablet computer or a desktop computer. For example, a testee 101 of the remote device 100 logs in an online webpage of the server 200 for example through a network browser or an application (App.) of the remote device 100, although the present disclosure is not limited to this, and the testee also may log in the online webpage of the server directly through a USB device plugged in the remote device.

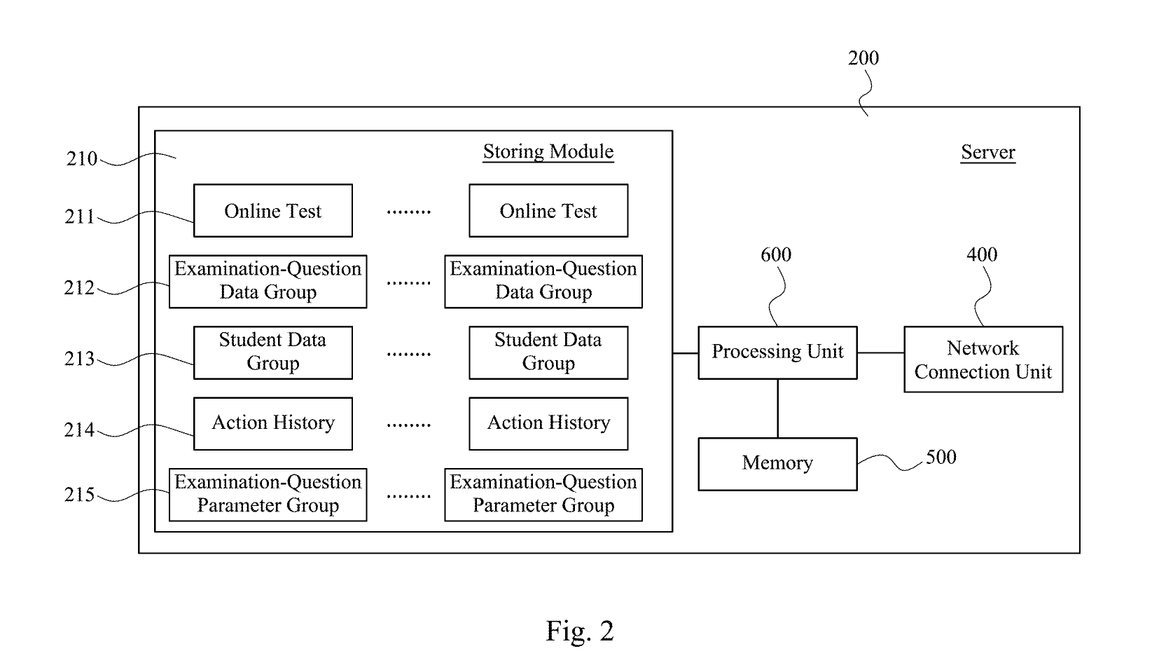

FIG. 2 illustrates a block diagram of the server 200 according to FIG. 1. As shown in FIGS. 1 and 2, specifically the server 200 includes a storing module 210, a network connection unit 400, a memory 500 and a processing unit 600. The processing unit 600 is electrically connected to the network connection unit 400, the storing module 210 and the memory 500. At least one online test 211 (e.g., table or webpage), at least one examination-question data group 212, at least one student data group 213 and at least one examination-question parameter group 215 are stored in the storing module 210. The examination-question data group 212 includes at last one examination question of any form, standard answers of various examination questions, a preset difficulty degree and the like. The examination question is used for being presented on the online test 211. The examination-question parameter group 212 includes previously statistical mean answering time, mean standard deviation and the like of various examination questions. A previous academic ability is evaluated for each testee 101 in advance, and if there is no previous academic ability available, a common value is used instead. The student data group 213 includes the personal data and the previous academic ability of the testee 101. Since the server 200 is connected to the remote device 100 through the network connection unit 400 by a network 300, the network connection unit 400 enables the testee 101 to log in the server 200 from the network 300 through the remote device 100 and to participate in the online test 211. The processing unit 600 is used for recording all of the action history 214 of the testee 101 who participates in the online test 211 through the remote device 100. The action history 214 includes for example the answer given by the testee 101 through the remote device 100 for each examination question and the answering times spent by the testee 101 for respective examination questions (referred to as the answering time of examination questions for short below); and subsequently determining whether the answer is a correct answer which matches the standard answer; and then if the answer is correct, providing a latest academic ability of the testee 101 based on a determination result whether the answering time of examination questions is within a predetermined range.

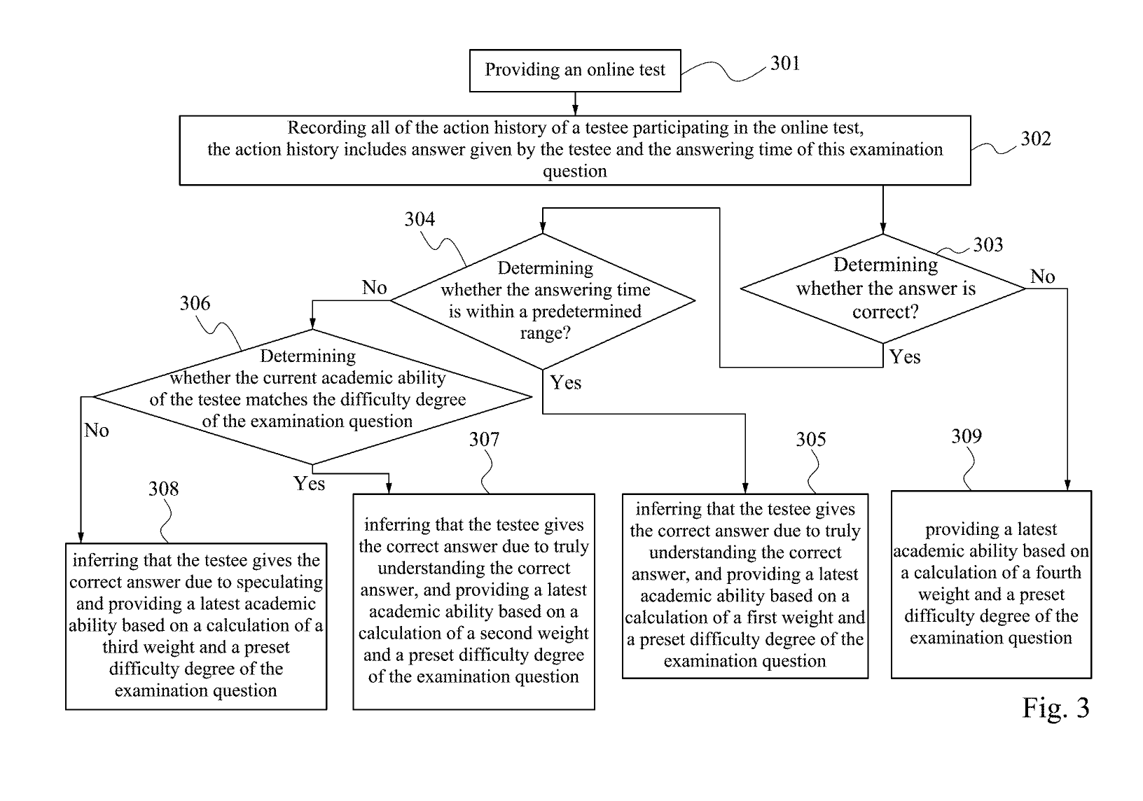

FIG. 3 illustrates a flow chart of a method for truly reflecting the ability of the testee through an online test 211 according to another embodiment of the present disclosure. As shown in FIG. 3, in this embodiment, after the hardware of the aforementioned server is ready for use, the method for truly reflecting the ability of the testee by the server through an online test includes steps 301-309 as follows.

In step 301, an online test including multiple examination questions is provided. In step 302, when a testee participates in the online test, all of the action history of the testee participating in the online test is recorded, wherein the action history includes the answer given by the testee for this examination question and the answering time of this examination question. In step 303, it is determined whether the answer is a correct answer which matches the standard answer; if so, the method proceeds to step 304, and if not, the method proceeds to the step 309. In step 304, it is determined whether the answering time is within a predetermined range; if so the method proceeds to the step 305, and if not the method proceeds to the step 306. In step 305, it is inferred the testee gives the correct answer since the testee truly understands the correct answer. Therefore, according to the determination result of the step 304, a first weight for distinguishing the real academic ability of the testee is provided for the academic ability of the testee accordingly, and the latest academic ability of the testee is provided through a calculation of the first weight and a difficulty degree of this examination question (described in details below). In step 306, a determination whether the previous academic ability of the testee matches the difficulty degree of the examination question is made; if so the method proceeds to the step 307, and if not the method proceeds to the step 308. In step 307, it is also inferred the testee gives the correct answer since the testee truly understands the correct answer. Therefore, according to the determination result of the step 306, a second weight for distinguishing the real academic ability of the testee is provided for the academic ability of the testee accordingly, and the latest academic ability of the testee is provided through a calculation of the second weight and a difficulty degree of this examination question. In this embodiment, the second weight is not limited to being the same as or different from the first weight, and the present disclosure is not limited to this. In step 308, it is inferred that the testee gives the correct answer by speculating. As such, according to the determination result of the step 306, a third weight for distinguishing the real academic ability of the testee is provided for the academic ability of the testee accordingly, and the latest academic ability of the testee is provided through a calculation of the third weight and a difficulty degree of this examination question. In this embodiment, since in step 308 it is inferred that the testee gives the correct answer by speculating, the third weight is set as less than the second weight, although the present disclosure is not limited to this. In step 309, according to the determination result of the step 303, a fourth weight for distinguishing the real academic ability of the testee is provided for the academic ability of the testee accordingly, and the latest academic ability of the testee is provided through a calculation of the fourth weight and a difficulty degree of this examination question. In this embodiment, since the answer given by the testee is wrong, the fourth weight is set as less than the third weight, although the present disclosure is not limited to this. In this embodiment, for example through a comparison among a comparison table, the determination result and the previous academic ability of the testee, one of the first to fourth weights is selected accordingly.

It should be understood that since different testees have different academic abilities, the provided first to fourth weights may vary adaptively corresponding to the different academic abilities of different testees, so as to show personal academic abilities. However, the present disclosure is not limited to this, and in other embodiments it is not necessary that the first to fourth weights vary corresponding to different academic abilities, wherein the first to fourth weights may be preset values.

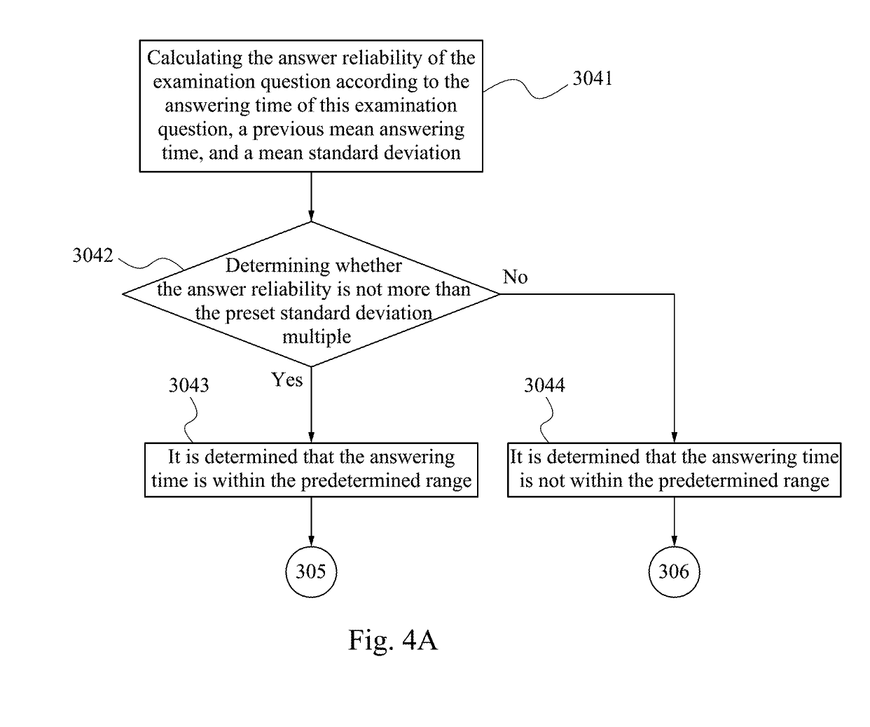

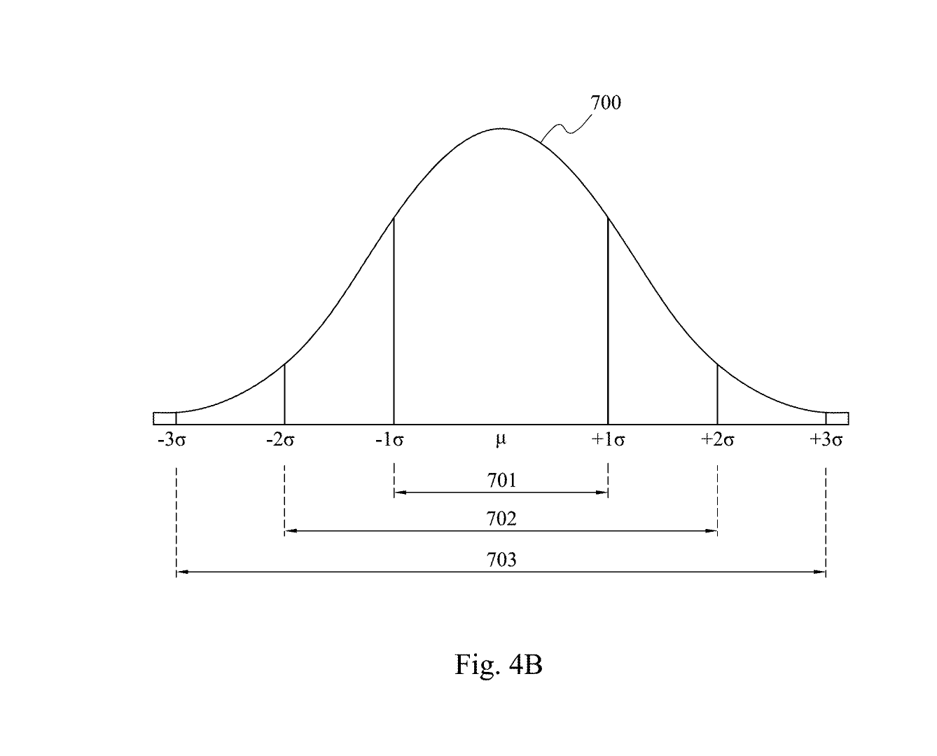

In the aforementioned embodiment, FIG. 4A illustrates a flow chart of substeps of the step 304. More particularly, as shown in FIG. 4A, the step 304 further includes substeps 3041-substeps 3044 as follows. In step 3041, according to the answering time of this examination question, a mean answering time calculated from the previous data of the same examination question, and a mean standard deviation calculated from the previous data of the same examination question, the answer reliability of the examination question is calculated. In step 3042, it is determined whether the answer reliability is not more than the preset standard deviation multiple; if so the method proceeds to the step 3043, and if not the method proceeds to the step 3044. In step 3043 it is determined that the answering time is within the predetermined range, and the method proceeds to the step 305. In step 3044 it is determined that the answering time is not within the predetermined range, and the method proceeds to the step 306.

For example, the answer reliability of a specific examination question estimates the reliability of the correct answer according to a score of mean answering time. The answer reliability satisfies the following relation expression (equation A):

$${z}_{i} = \vert \frac{{t}_{i} - {\overline{t}}_{i}}{{σ}_{i}} \vert$$

wherein, the answer reliability is zᵢ, the answering time is tᵢ, the mean answering time is t̅ᵢ, and the mean standard deviation is σᵢ.

For example, FIG. 4B illustrates a normal distribution diagram 700 of all the previous answering times of a single examination question. As shown in FIGS. 4A and 4B, the normal distribution diagram 700 is depicted according to the answering time of the examination question, a mean answering time calculated from the previous data of the same examination question, and a mean standard deviation calculated from the previous data of the same examination question. If the preset standard deviation multiple is set as one standard deviation (±1^{σ}), i.e., the predetermined range being the range 701 of the normal distribution diagram 700, when the answer reliability is equal to or less than the preset standard deviation multiple, it is determined that the answering time of the examination question is within the range 701, and thus the method proceeds to the aforementioned step 305. However, the present disclosure is not limited to this, and the preset standard deviation multiple may also be preset as two or three multiples of the standard deviation (±2^{σ} or ±3^{σ}), i.e. the predetermined range being the range 702 or 703 of the normal distribution diagram 700.

However, the present disclosure is not limited to this, and those of ordinary skills in the art can flexibly select the predetermined ranges of different embodiments according to practical demands, such as the front end range or the back end range of all the previous answering times (e.g., the left or right half segment of the normal distribution diagram).

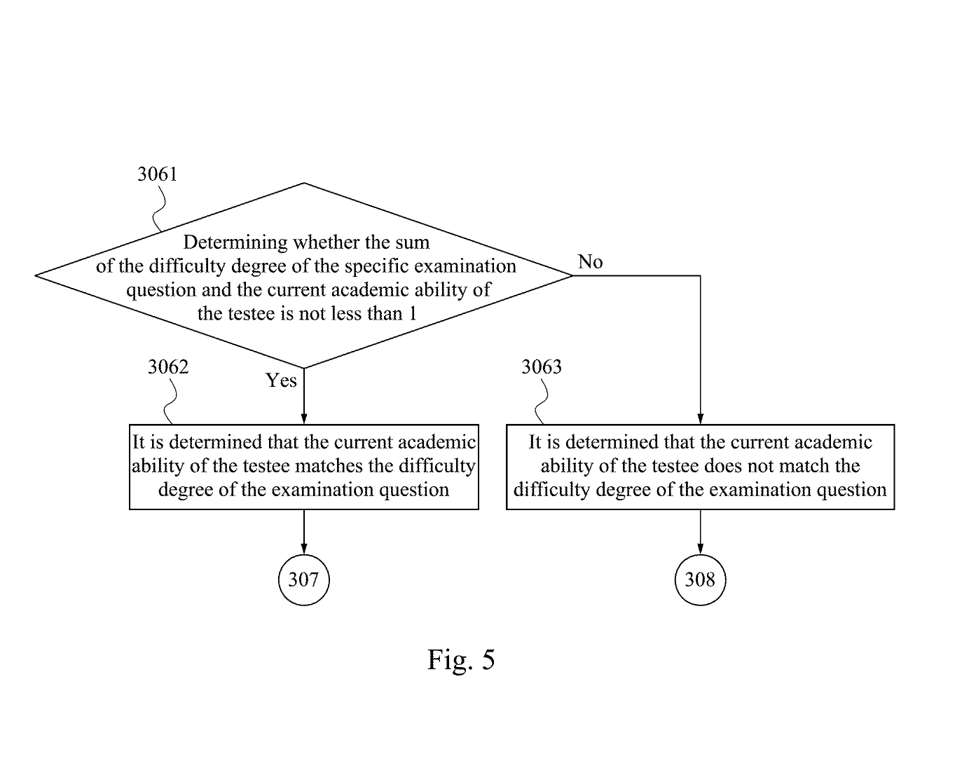

In the aforementioned embodiment, more particularly FIG. 5 illustrates a flow chart of substeps of the step 306 of FIG. 3. As shown in FIG. 5, the step 306 further includes substeps 3061-3063 as follows. In the step 3061 it is determined whether the sum of the difficulty degree of the specific examination question and the previous academic ability of the testee is not less than a preset threshold (e.g., the numerical value 1), and if so the method proceeds to the step 3062, if not the method proceeds to the step 3063. Both of the difficulty degree of the specific examination question and the previous academic ability of the testee are within the range formed by 0-1, and the difficulty degree is higher when the difficulty degree is closer to 0, and in contrast the academic ability of the testee is better when the previous academic ability of the testee is closer to 1. In step 3062 when it is determined that the sum of the difficulty degree of the specific examination question and the previous academic ability of the testee is not less than a preset threshold (e.g., the numerical value 1), it is inferred that the testee has the ability to give the right answer for this specific examination question, and thus the previous academic ability of the testee matches the difficulty degree of the specific examination question. Vice versa, in step 3063 when it is determined that the sum of the difficulty degree of the specific examination question and the previous academic ability of the testee is less than a preset threshold (e.g., the numerical value 1), it is inferred that it is not easy for the testee to give the right answer for this specific examination question, and thus it is determined that the previous academic ability of the testee does not match the difficulty degree of the specific examination question.

Furthermore, when it is determined whether the sum of the difficulty degree of the specific examination question and the previous academic ability of the testee is less than a preset threshold, for practical considerations the error is corrected by subtracting an error value (ε, ε ∈ (0˜1)) from the preset threshold.

In the aforementioned embodiment, more particularly, in steps 305, 307 and 308-309, during the reckoning of the latest academic ability of the testee, since the second weight, third weight and fourth weight vary from each other, the latest academic ability p satisfies the following relation expression (equation B):

$$p = \frac{{\sum }_{i = 1}^{n} ( 1 - {d}_{i} ) \times {a}_{i}}{n}$$

wherein, the number of examination questions is n, the difficulty degree of each examination question is dᵢ, one of the first to fourth weights is aᵢ, wherein 1≧dᵢ≧0 and 1≧aᵢ≧0, but in the present disclosure the aᵢ and dᵢ are not limited to being between 1 and 0.

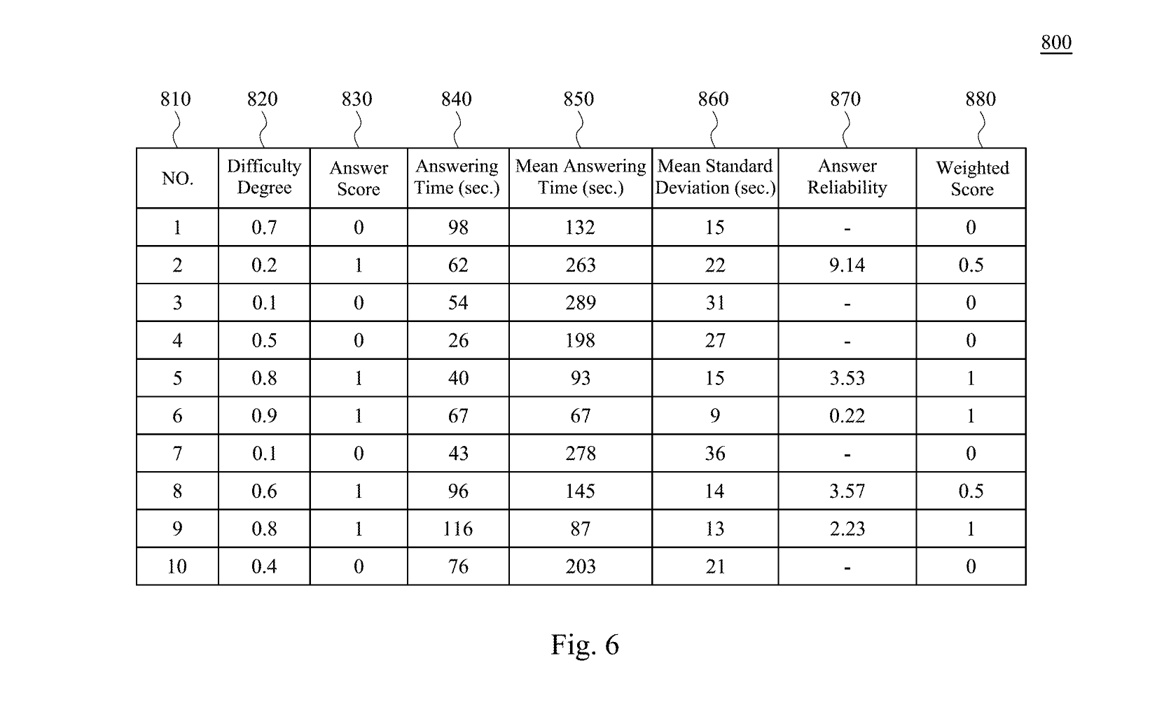

As shown in FIG. 6, it illustrates an examination-question data table 800 used for reckoning the latest academic ability of the testee in FIG. 3. The examination-question data table 800 helps to illustrate how the aforementioned steps 305, 307 and 308-309 reckon the latest academic ability of the testee. For example, when a certain online test includes 10 examination questions, the examination-question data table 800 has a numbering field 810, a difficulty-degree field 820, a answer score field 830 (T/F, 1 for correct and 0 for wrong), a answering time field 840, a mean-answering-time field 850, a mean-standard-deviation field 860, an answer-reliability field 870 and a weighted score field 880 (T/F* aᵢ) for each examination question. In this example, the difficulty degree the dᵢ, the mean answering time t̅ᵢ and the mean standard deviation σᵢ are filled into the corresponding fields in advance, and when answers are given by the testee sequentially, the answer score (T/F), answering time tᵢ and weighted score (T/F* aᵢ) are sequentially calculated and filled into the corresponding fields.

In this example, since both in steps 305 and 307 it is inferred that the testee gives the correct answer since he/she truly understands the correct answer, in step 308 it is inferred that the testee gives the correct answer just by speculating, and in step 309 the answer given by the testee is wrong, the first and second weights are set as 100%, the third weight is set as 50%, the fourth weight is set as 0, the preset standard deviation multiple is 2, and the error value is 2. However, the present disclosure is not limited to this, and those of ordinary skills in the art can flexibly select different numerical ranges according to practical demands.

As such, after the determination through steps 303-309 and the calculation of equations (A and B), the obtained latest academic ability of the testee is 0.25, and as compared if how the correct answer is given by the testee is not considered the academic ability of the testee is 0.33. As such, it can be seen that the present disclosure can precisely determine the real ability degree of the user.

Furthermore, after the test is completed, the method of this embodiment may optionally include the following steps: the step of replacing the latest academic ability of the testee and updating the previous academic ability of the testee, the step of reporting the latest academic ability to the testee, the step of correcting the mean answering time and the mean standard deviation of the examination question according to the answering time of the testee for the examination question, and/or the step of modifying the difficulty degree of the examination question according to the answering time of the testee for the examination question.

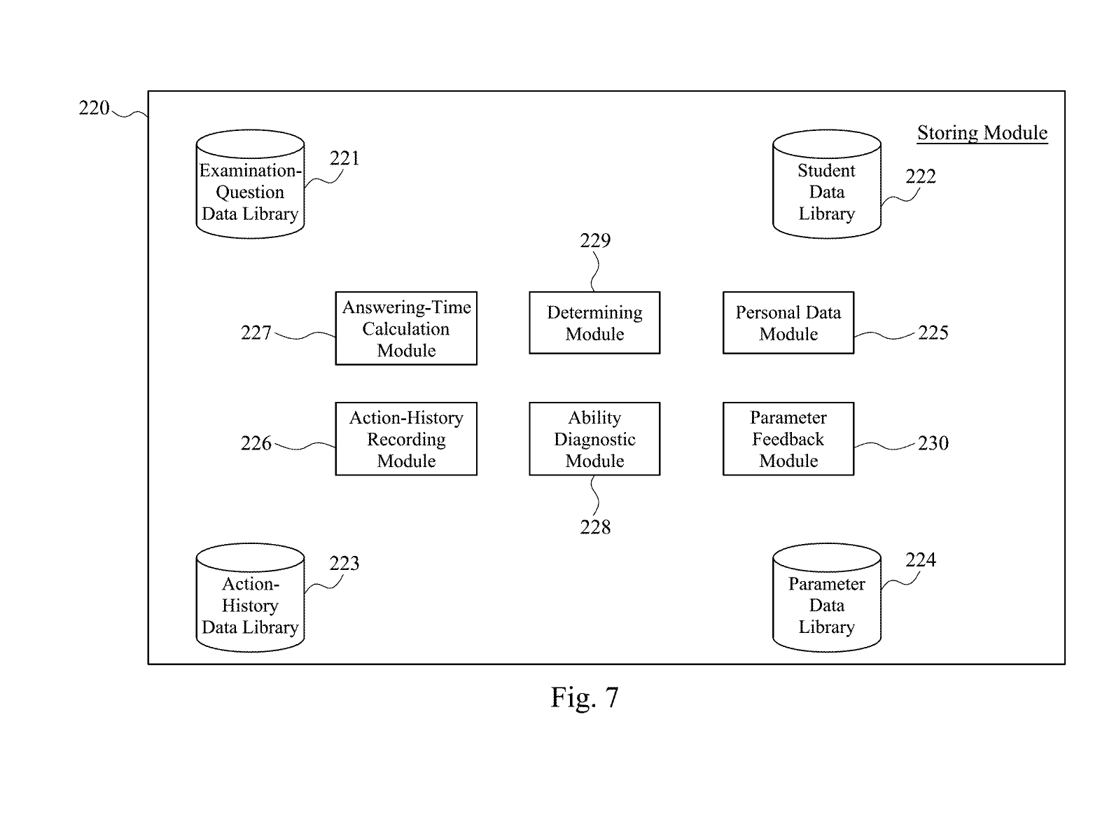

FIG. 7 illustrates a block diagram of the server according to another embodiment of the present disclosure. As shown in FIGS. 2 and 7, particularly in other embodiments, the storing module 220 further includes an examination-question data library 221, a student data library 222, an action-history data library 223 (learning records storage, LRS) and a parameter data library 224. These data libraries are not limited to being located in the same server 200, the same storing magnetic disk or the same storing area. The online test 211, the online test 211 of the examination-question data group 212 (such as a table or a webpage), each examination question, the standard answer and difficulty degree of each examination question are all stored in the examination-question data library 221. All of the student data groups 213 of respective testees are stored in the student data library 222. All of the action history 214 of each testee participating in the online test 211 through the remote device is recorded in the action-history data library 223. The action history 214 includes the answer given by each testee for each examination question and the starting answering time and final answering times of each examination question. The difference value between the starting answering time and final answering times is the aforementioned answering time. The answering time is not limited to being obtained when it is determined whether the answer is correct. The previous mean answering time and mean standard deviation of examination questions of each examination-question parameter group 215 are all stored in the parameter data library 224.

The storing module 220 further stores a personal data module 225, an action-history recording module 226, an answering-time calculation module 227, an ability diagnostic module 228, a determining module 229, and a parameter feedback module 230. The personal data module 225 is used for recording the latest academic ability of the testee into the student data library 222. The action-history recording module 226 is used for recording all of the action history 214 of the testee which participates in the online test through the remote device into the action-history data library 223 before it is determined whether the answer is correct. The answering-time calculation module 227 calculates the answering time spent by the testee for answering the examination question through the remote device according to all of the action history 214, accumulates the previous mean answering time and mean standard deviation of the examination question, and updates the latest result into the parameter data library 224. The ability diagnostic module 228 is used for calculating an answer reliability of the examination question, and the sum of the previous academic ability of the testee and the preset difficulty degree of the examination question according to the answering time, the mean answering time and the mean standard deviation of the examination questions. The determining module 229 is used for determining whether the answer is correct, whether the answer reliability is not more than the preset standard deviation multiple, and whether the sum of the previous academic ability of the testee and the difficulty degree of the examination question is not less than 1. The ability diagnostic module 228 further performs a calculation of the difficulty degree of the examination question and the weight provided by a corresponding determination result based on different determination results from the determining module 229, so as to provide a latest academic ability and update the previous academic ability into the personal data module 225. The parameter feedback module 230 is used for correcting the difficulty degree of the examination question according to the answering time of the examination question, and accumulating the previous mean answering time and mean standard deviation of the examination question according to the answering time of the examination question.

As such, since the system entirely records the action history of the testee participating in the online test, such as the answer of the examination question, the answering time and the like, no time recording element or similar element is needed to be additionally developed, and then the latest academic ability of the testee is calculated accordingly through the action history.

It should be understood that the aforementioned personal data module, the action-history recording module, the answering-time calculation module, the ability diagnostic module, the determining module and the parameter feedback module may also be embodied as a hardware circuit. Those of ordinary skills in the art can flexibly select the embodiment if desired, wherein it is not necessary that all of the components are embodied as a software program or hardware circuit, and it may be the case that some of the components are embodied as a software program, and the others are embodied as a hardware circuit.

Furthermore, the method for truly reflecting ability of a testee through an online test may be implemented by a program and stored in a non-transitory computer-readable storage medium. Accordingly, after a computer accesses the non-transitory computer-readable storage medium above, the system for truly reflecting ability of a testee through an online test may be executed. The non-transitory computer-readable storage medium may be a Read Only Memory (ROM), a Flash Memory, a floppy disk, a hardware disk, an optical disc, a flash drive, a magnetic tape, a data library accessible from the network. It also may be any other non-transitory computer-readable storage medium with the same or equivalent function in this field.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for truly reflecting ability of a testee through an online test, comprising:
providing an online test to be participated by a testee, wherein the online test comprises at least one examination question;
recording an answer of the examination question given from the testee and answering time spent by the testee;
determining whether the answer is correct; and
when the answer is determined to be correct, providing a latest academic ability of the testee according to a determination result whether the answering time of the testee is within a predetermined range.

2. The method of claim 1, wherein the step of providing the latest academic ability of the testee according to the determination result whether the answering time is within the predetermined range comprises:
determining whether the answering time is within the predetermined range; and
when it is determined that the answering time is within the predetermined range, providing a first weight accordingly based on the determination result, and providing the latest academic ability based on a calculation of the first weight and a preset difficulty degree of the examination question.

3. The method of claim 2, wherein when it is determined that the answering time is not within the predetermined range, further determining whether the previous academic ability of the testee matches the preset difficulty degree of the examination question;
When it is determined that the previous academic ability matches the difficulty degree of the examination question, providing a second weight accordingly, and providing the latest academic ability through the calculation of the second weight and the difficulty degree of the examination question.

4. The method of claim 3, wherein when it is determined the previous academic ability does not match the difficulty degree of the examination question, providing a third weight accordingly, and providing the latest academic ability through the calculation of the third weight and the difficulty degree of the examination question, wherein the third weight is less than the second weight.

5. The method of claim 4, wherein when it is determined that the answer is not correct, providing a fourth weight accordingly, and providing the latest academic ability through the calculation of the fourth weight and the preset difficulty degree of the examination question, wherein the third weight is between the second weight and the fourth weight.

6. The method of claim 5, wherein when the online test comprises a plurality of the at least one examination questions, the number of the examination questions is n, the difficulty degree of each examination question is dᵢ, one of the first to fourth weights is aᵢ, and the latest academic ability is p, the online test satisfies the following relation expression:
$$p = \frac{{\sum }_{i = 1}^{n} ( 1 - {d}_{i} ) \times {a}_{i}}{n} ,$$
wherein 1≧dᵢ≧0 and 1≧aᵢ≧0.

7. The method of claim 2, wherein determining whether the answering time is within the predetermined range comprises:
calculating answer reliability of the examination question according to the answering time, a mean answering time of the examination question, and a mean standard deviation;
determining whether the answer reliability is not more than a preset standard deviation multiple; and
when it is determined that the answer reliability is no more than the preset standard deviation multiple, determining whether the answering time is within the predetermined range, so as to provide the latest academic ability through the calculation of the first weight and the difficulty degree.

8. The method of claim 7, wherein when the answering time is tᵢ, the mean answering time is t̅ᵢ, the mean standard deviation is σᵢ, the answer reliability is zᵢ, the online test satisfies the following relation expression:
$${z}_{i} = \vert \frac{{t}_{i} - {\overline{t}}_{i}}{{σ}_{i}} \vert$$

9. The method of claim 3, wherein determining whether the previous academic ability matches the difficulty degree comprises:
determining whether a sum of the previous academic ability and the difficulty degree is not less than 1, wherein both the difficulty degree and the previous academic ability are within a range formed by 0-1, the difficulty degree from 0 to 1 represents the difficulty degree from difficult to easy, and the previous academic ability from 0 to 1 represents the previous academic ability from bad to good; and
When it is determined that the sum of the previous academic ability and the difficulty degree is not less than 1, determining whether the previous academic ability matches the difficulty degree, so as to provide the latest academic ability through the calculation of the second weight and the difficulty degree.

10. The method of claim 1, further comprising:
replacing the previous academic ability of the testee by the latest academic ability; and
reporting the latest academic ability to the testee online.

11. The method of claim 1, further comprising:
correcting a mean answering time of the examination question and a mean standard deviation based on the answering time spent by the testee for answering the examination question.

12. The method of claim 1, further comprising:
correcting the preset difficulty degree of the examination question according to the answering time spent by the testee for answering the examination question.

13. The method of claim 1, further comprising:
recording all of the action history of the testee participating in the online test before the step of determining whether the answer is correct.

14. A system for truly reflecting ability of a testee through an online test, comprising:
a storing module for storing at least one online test having at least one examination question;
a network connection unit provided to be participated by a testee through at least one remote device via a network; and
a processing unit electrically connected to the storing module and the network connection unit, for recording answer given by the testee for answering the examination question through the remote device and the answering time spent by the testee, determining whether the answer is correct, and when the answer is determined to be correct, accordingly providing a latest academic ability of the testee according to a determination result whether the answering time of the testee is within a predetermined range.

15. The system of claim 14, further comprising:
an action-history recording module for recording all of the action history of the testee who participates in the online test through the remote device into the storing module.

16. The system of claim 15, further comprising:
an answering-time calculation module for calculating the answering time spent by the testee for answering the examination question through the remote device based on all of the action history, and for accumulating and updating a previous mean answering time and the mean standard deviation of the examination question.

17. The system of claim 16, further comprising:
an ability diagnostic module for calculating the answer reliability, and a sum of the previous academic ability of the testee and the preset difficulty degree of the examination question according to the answering time, the mean answering time of the examination question and the mean standard deviation; and
a determining module for determining whether the answer is correct, whether the answer reliability is not more than the preset standard deviation multiple, and whether the sum of the previous academic ability of the testee and the difficulty degree of the examination question is not less than 1,
wherein the ability diagnostic module further performs a calculation of the difficulty degree of the examination question and the weight provided by a corresponding determination result based on different determination results from the determining module, so as to provide the latest academic ability for updating the previous academic ability.

18. The system of claim 17, further comprising:
a parameter feedback module for correcting the preset difficulty degree of the examination question according to the answering time of the examination question.

19. The system of claim 14, wherein the network connection unit is further used for transmitting the latest academic ability to the remote device.

20. A non-transitory computer-readable storage medium storing program routines for causing a computer to perform a method for truly reflecting the ability of a testee through an online test, wherein the method comprises:
providing an online test to be participated by a testee, wherein the online test comprises at least one examination question;
recording an answer of the examination question given from the testee and answering time spent by the testee;
determining whether the answer is correct; and
when the answer is determined to be correct, providing a latest academic ability of the testee according to a determination result whether the answering time of the testee is within a predetermined range.
